(19) United States
(12) Patent Application Publication
(10) Pub. No.: US 2012/0006308 A1
(43) Pub. Date: Jan. 12, 2012

(54) Piston for a Two-Stroke Engine

(76) Inventors: Nagesh Mavinahally, Los Angeles, CA (US); Bernardo Herzer, Los Angeles, CA (US); David Kostka, Los Angeles, CA (US)

(21) Appl. No.: 13/176,745

(22) Filed: Jul. 6, 2011

Related U.S. Application Data
(60) Provisional application No. 61/362,294, filed on Jul. 7, 2010.

(51) Int. Cl. F02B 33/30

(52) U.S. Cl. 123/73 PP

(57) ABSTRACT

A transfer passage design for a two stroke internal combustion engine that allows for regulation of the air/fuel flow as the piston nears the bottom of its stroke. Additionally, a cut out in the skirt of the piston may allow for additional gaseous communication between the crankcase chamber and the transfer passage.

This patent application claims the benefit of, priority of, and incorporates by reference U.S. Provisional Patent Application Ser. No. 61/362,294, entitled “Piston for a Two-Stroke Engine” by Nagesh Mavinahally, Bernardo Herzer, and David Kostka filed on Jul. 7, 2010.

### BACKGROUND OF THE INVENTION

1. Field of the Invention

This invention relates to a two stroke engine, specifically an improved two stroke engine piston and cylinder port design.

2. Description of the Related Art

Conventional low cost two-stroke engines, particularly the ones used in lawn and garden applications typically have higher emissions compared to higher cost stratified engines. The emissions in a conventional two-stroke engine are higher due to scavenging loss of fuel-air mixture, particularly in a simpler port and piston design.

The design described here lowers the emission in a conventional two-stroke engine without adding cost or complexity to the engine.

### BRIEF SUMMARY OF THE INVENTION

Accordingly, the design for a new and improved method of lowering the emissions and lowering the fuel consumption in a two-stroke engine is disclosed. This design may be applied to the hand-held two-stroke engines, and lawn and garden engines in general.

The low cost two-stroke engine is especially suited for hand-held, lawn and garden equipments such as trimmers, blowers, chainsaws, generator engines, and mopeds.

This low cost two-stroke engine reduces the scavenging loss of unburned fuel and therefore reduces the pollutants and improves the efficiency of the engine. In the improved design, the piston controls the scavenging process by restricting the flow of air-fuel mixture when the piston is closer to and at bottom dead center (BDC).

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 shows a sectional side view of an embodiment of the engine when the piston is close to BDC.

FIG. 2 shows a sectional front view of an embodiment of the engine shown in FIG. 1.

FIG. 3 shows a sectional side view of an embodiment of the engine when the piston is at BDC.

FIG. 4 shows the a sectional front view of an embodiment of the engine shown in FIG. 3.

FIG. 5 shows the a cross sectional view (section A-A of FIG. 3) of the transfer ports of an embodiment of the engine.

### DETAILED DESCRIPTION

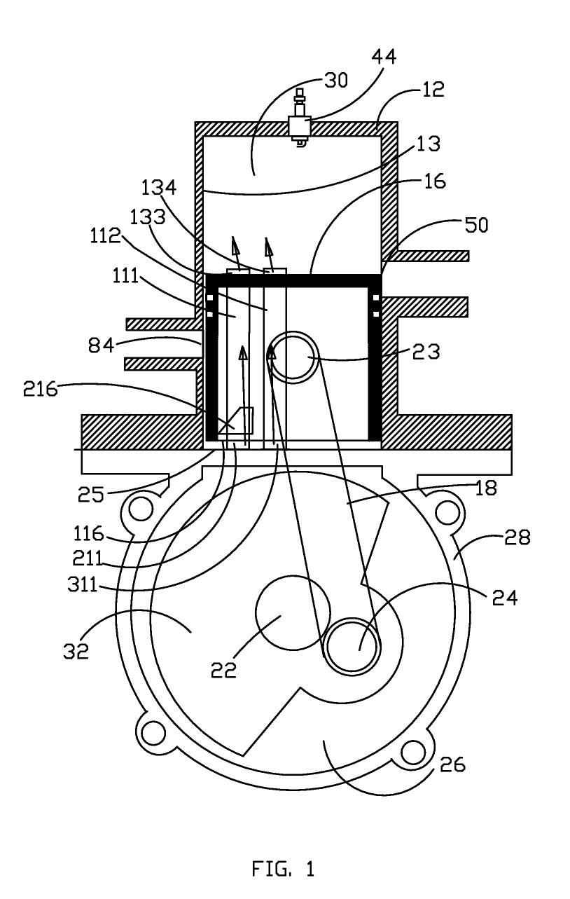

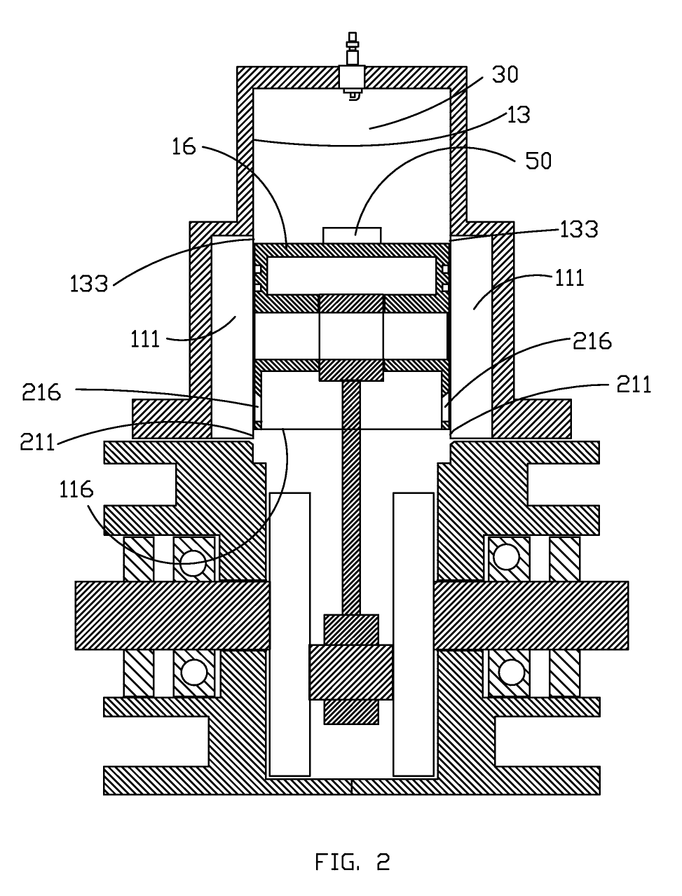

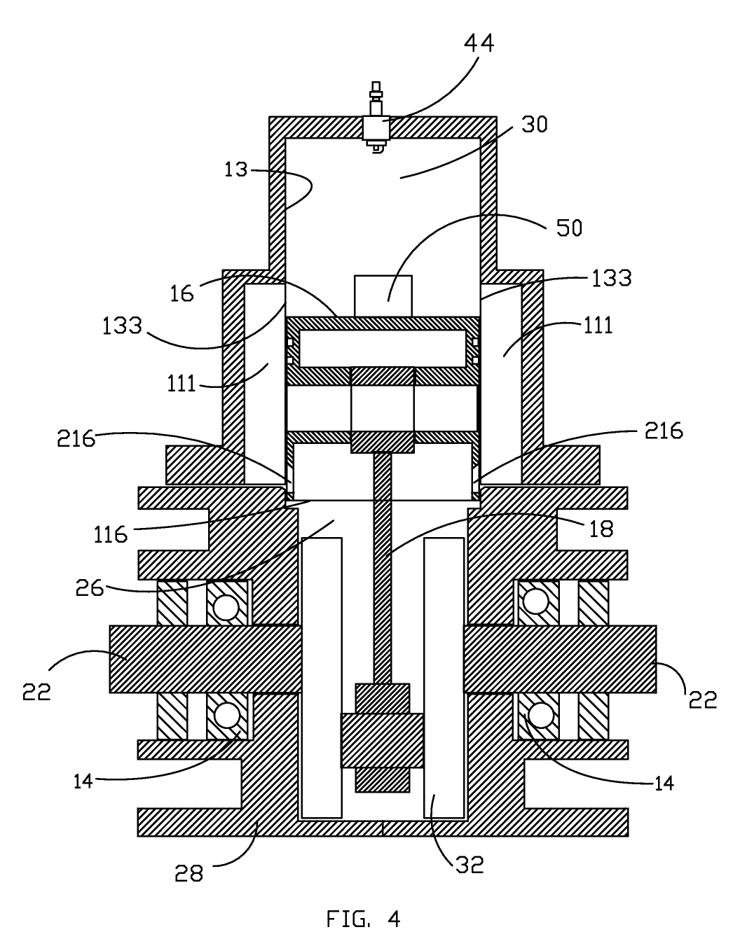

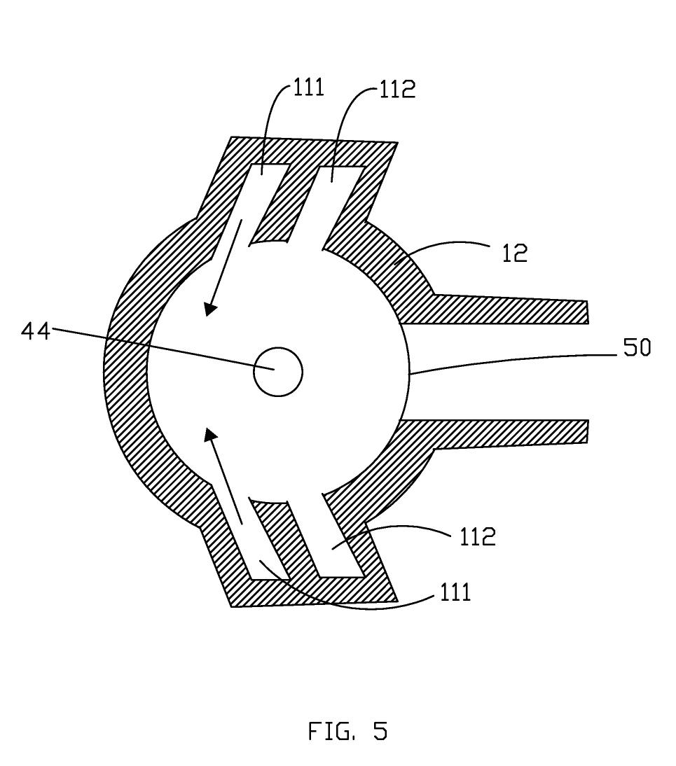

A two-stroke engine constructed in accordance with the preferred embodiment, is shown in FIG. 1 through FIG. 5. FIG. 1 through FIG. 5 depict an embodiment of a two-stroke engine having two pairs of transfer passages 111 and 112; one pair on each side of the exhaust port 50. The engine has a cylinder 12 and a crankcase 28 which are firmly fastened with a gasket 25 in between the cylinder and the crankcase 28. As seen in FIG. 5, the transfer passages 111 112 may have outer side walls formed from the casting of the cylinder 12. The crankcase 28 has a crankcase chamber 26 having a crankshaft 22 for reciprocatively moving a piston 16 inside the cylinder bore 13 through a connecting rod 18. The crankshaft 22 is supported by the crankcase 28 through a pair of main bearings 14 (FIG. 4) on either side of the crank pin 24. The piston 16 has openings (cut outs) 216 on the skirt that align with the front transfer passages 111, which is farthest from the exhaust port 50. The opening 216 may be aligned with both the front passage 111 and rear passage 112, just the front passage 111, or just the rear passage 112. The pair of rear passages 112 may be deleted and just one pair of passages 111 may be sized and shaped to perform the same function. The transfer passage inlet ports 211 and 311 at the lower ends of the transfer passages 111 and 112, unlike with conventional engines (also unlike U.S. Pat. No. 6,513,465), do not open into the crankcase chamber 26 via openings at the bottom of the passages 111 and 112. The inlet ports 111 and 112 are blocked at the bottom by the gasket 25 and or a wall on the crankcase 28. The transfer passages 111 and 112 are, however, open on the side that contacts the piston 16. Thus the piston 16 acts as a movable gate that alternately opens and closes the transfer passages 111 and 112 at the top which is outlet ports 133 134 and at the bottom which is inlet ports 211 and 311. When the piston is close to BDC, as seen in FIG. 2, the transfer passages 111 provide a gaseous communication between the combustion chamber 30 above the piston, at the transfer passage outlet port 133, and the crankcase chamber 26 below the piston through transfer passage inlet ports 211 and 311 and also through the opening 216 on the piston skirt.

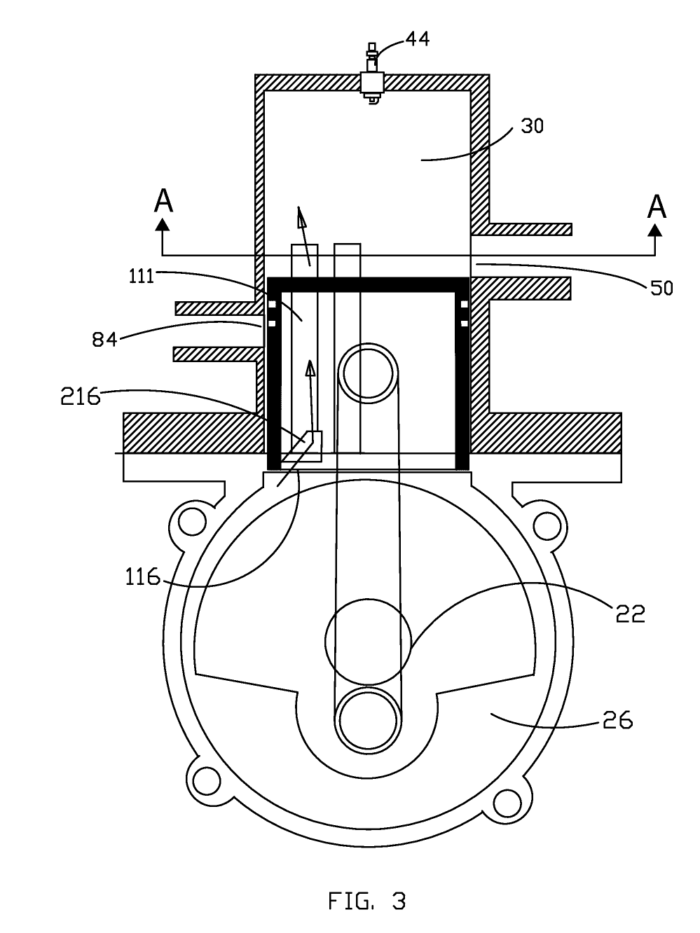

In the operation of the engine, as the piston 16 moves upward to compress the air-fuel mixture in the combustion chamber 30, it first closes the transfer passages 111 and then closes the exhaust port 50. At the same time, pressure in the crankcase chamber 26 reduces as the piston continues to ascend. As the piston 16 continues to ascend, it closes the exhaust port 50 and shortly later the intake port 84 is opened by the lower edge 116 of the piston 16. Thus fresh air-fuel mixture is drawn into the crankcase chamber 26. The air-fuel mixture in the combustion chamber 30 is compressed by the ascending piston 16 and is ignited by the spark from the spark plug 44 causing high combustion pressure to push the piston 16 down generating the power. As the piston 16 descends, the piston 16 first closes the intake port 84 and as the piston 16 continues to descend, the pressure increases in the crankcase chamber 26. As the piston 16 continues to descend, the exhaust port 50 is opened first. After the piston 16 descends a little further, the outlet ports 133 of the transfer passages 111 are opened and the inlet ports 211 and 311 are already open. At this time, the air-fuel mixture in the crankcase chamber 26 is pushed toward the combustion chamber 30 through the fully open inlet ports 211 and 311. As the piston continues to descend, the lower edge 116 of the piston 16 begins to close the transfer passage inlet ports 211 and 311 as shown in FIGS. 3 and 4. However, since the cut outs 216 are aligned with the transfer passages 111, the air-fuel mixture continues to flow into the combustion chamber 30, but at a rate determined by the shape and size of the cut outs 216 on the piston skirt. Thus the discharge rate of the air-fuel mixture is now regulated by the shape of the cut outs 216. The flow rate is reduced as the piston 16 approaches BDC and it is possible to completely cut off the flow. Reduction in flow of air-fuel mixture thus minimizes the loss of fresh air-fuel mixture through the exhaust port 50. Thus a significant reduction in emission may be seen with the engine built according to this embodiment.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

What is claimed is:

1. A transfer passage design for a two stroke internal combustion engine comprising:
a cylinder includes an exhaust port, intake port, and combustion chamber;
a piston;
a crankcase includes a crankcase chamber and is attached to said cylinder; and
a transfer passage with outer side walls formed from casting of said cylinder, a bottom being closed off, and with a side wall that contacts said piston, wherein said piston acts as a movable gate that alternately opens and closes the transfer passage at the top through an outlet port and at the bottom through an inlet port.

2. The transfer passage design of claim 1 wherein said piston incorporates a cut out at the skirt of said piston, said cut out aligns with said transfer passage, allowing gas flow between said transfer passage and said crankcase chamber, whereby said cut out regulates flow of air-fuel mixture in a two-stroke engine.

3. The transfer passage design of claim 1 wherein said piston, when near BDC, partially closes said inlet port and partially opens said outlet port, wherein a gaseous communication between said crankcase chamber and said combustion chamber is opened via said transfer passage.

4. The transfer passage design of claim 3 wherein said piston, when at BDC, partially closes said inlet port.

5. The transfer passage design of claim 3 wherein said piston, when at BDC, completely closes said inlet port.

6. The transfer passage design of claim 1 further comprising a pair of transfer passages, with each transfer passage on either side of said exhaust port.

7. The transfer passage design of claim 6 further comprising two pairs of transfer passages, with each transfer passage from each pair being on either side of said exhaust port.

8. The transfer passage design of claim 6 wherein said piston incorporates cut outs at the skirt of said piston, said cut outs align with said transfer passages, allowing gas flow between said transfer passages and said crankcase chamber, whereby said cut out regulates flow of air-fuel mixture in said two-stroke engine.

9. The transfer passage design of claim 8 wherein said piston, when near BDC, partially closes at least one of said inlet ports and partially opens at least one of said outlet ports, wherein a gaseous communication between said crankcase chamber and said combustion chamber is opened via at least one of said transfer passages.

10. The transfer passage design of claim 9 wherein said piston, when at BDC, partially closes at least one of said inlet ports.

11. The transfer passage design of claim 9 wherein said piston, when at BDC, completely closes at least one of said inlet ports.

12. The transfer passage design of claim 9 wherein said bottom of transfer passages being closed off are closed off by a wall of said crankcase, with or without a gasket seal in between.
